(19) United States
(12) Patent Application Publication
(10) Pub. No.: US 2024/0179291 A1
(43) Pub. Date: May 30, 2024

(54) GENERATING 3D VIDEO USING 2D IMAGES AND AUDIO WITH BACKGROUND KEYED TO 2D IMAGE-DERIVED METADATA

(71) Applicant: Sony Interactive Entertainment LLC, San Mateo, CA (US)

(72) Inventor: Daisuke Kawamura, San Mateo, CA (US)

(21) Appl. No.: 18/058,865

(22) Filed: Nov. 26, 2022

(51) Int. Cl. H04N 13/351; G06F 3/04847; G06T 7/40; G06T 13/40; G06V 10/74; G06V 40/16; G06V 40/20; H04M 1/72427; H04N 5/265

(52) U.S. Cl. CPC H04N 13/351; G06F 3/04847; G06T 7/40; G06T 13/40; G06V 10/761; G06V 40/174; G06V 40/20; H04M 1/72427; H04N 5/265; G06T 2207/30201

(57) ABSTRACT

3D video is generated based on end user 2D photos and videos stored in a section of memory designated as 3D memory. Characters in the 3D video are based on the textures of people in the 2D images, and environmental background in the 3D video is selected from a model most closely resembling images in the 2D video. The 3D video is updated over time such that a user can select which period of a person's life to view in 3D

### FIELD

The present application relates generally to 3D spatial memory and more particularly to generating 3D videos with a timeline based on end user 2D video.

### BACKGROUND

As understood herein, people (“end users”) generate and store 2D images and video of the same subject such as a child over a prolonged period such as several years.

### SUMMARY

Present principles also understand that watching stored reproductions of personal audio-video files can be enhanced by automatically converting what is essentially a partial history of the subject into 3D with interactive features. End users can watch and interact with the copy of their family and friends in the 3D video presented on, e.g., a holographic display device. The system generates 3D interactive contents from existing video and photos. The main purpose of the 3D content is to use it in 3D viewing devices such as 3D spatial displays, holographic displays, and VR headsets. Created characters and environments can be controlled using an input device such as a gamepad or mouse and keyboard.

The system analyzes the situation/story from various information that video/photo contain like human body motion, facial emotion, environment type, location and time. Based on this information, objects and features in a prepared 3D contents source (e.g., human body, animation, environment map, lighting, sound effects, etc.) are identified for generating automatically and transparently to the user final 3D video. A part of the textures and data are gathered from the 2D video, including human facial textures, wall and floor textures, audio such as human voices in the 2D video, and environment sounds.

The 3D memory content keeps updating. The characters (e.g., parents or children grow up in the 3D video with the real users. When a user wants to watch a past memory, the user can control the time in the virtual world being viewed.

Accordingly, an apparatus includes at least one processor configured to access 2D image information in storage, and using the 2D image information, generate 3D interactive video at least in part by matching at least one feature of at least one object in the 2D image information to at least one 3D model.

In some examples, the processor is configured to receive from at least one input device at least one interaction signal, and alter presentation of the 3D interactive video at least in part based on the interaction signal.

The input device may be, e.g., at least one touch element on at least one computer simulation controller and/or at least one microphone.

In some implementations the processor can be programmed to alter presentation of the 3D interactive video responsive to an incoming telephone call.

The feature of the 2D image information on which 3D video generation is based may include one or more of human image texture, human image motion, human image facial emotion, environment type.

In some examples the processor can be programmed to alter presentation of the 3D interactive video responsive to input from a time slider input element.

In another aspect, a device includes at least one computer storage that is not a transitory signal and that in turn includes instructions executable by at least one processor to identify at least one texture of at least one human image in a 2D image. The instructions are executable to use the texture to generate a 3D character. The instructions further are executable to identify at least one environmental background type in the 2D image and based at least in part on the environmental background type in the 2D image, select an environmental background type model, which is used to generate a 3D environmental background. The instructions are executable to merge the 3D environmental background with the3D character to generate a 3D video.

In another aspect, a method includes accessing 2D images in a 3D spatial memory and automatically creating a 3D video based on the 2D images at least in part using an environmental background model selected based on an environmental background in the 2D images as classified by a machine learning (ML) model and a texture of an image of a human face in the 2D images.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system architecture consistent with present principles;

FIG. 3 illustrates an example holographic 3D display;

FIG. 4 illustrates example overall logic in example flow chart format;

FIG. 5 illustrates example 3D image generation logic in example flow chart format;

FIGS. 6 and 7 illustrate example screen shots illustrating how the environment background in 3D may differ from a 2D image from whence the 3D image is generated;

FIG. 8 illustrates example 3D environment generation logic in example flow chart format;

FIG. 9 illustrates example 3D environment modification logic in example flow chart format;

FIG. 10 illustrates example 3D image generation logic based on user ID in example flow chart format;

FIG. 11 illustrates example detailed use case logic in example flow chart format;

FIGS. 12 and 13 illustrate example screen shots illustrating time-based viewing of 3D video;

FIG. 14 illustrates 3D video responding to a telephone call; and

FIG. 15 provides further illustration of details of example implementations.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

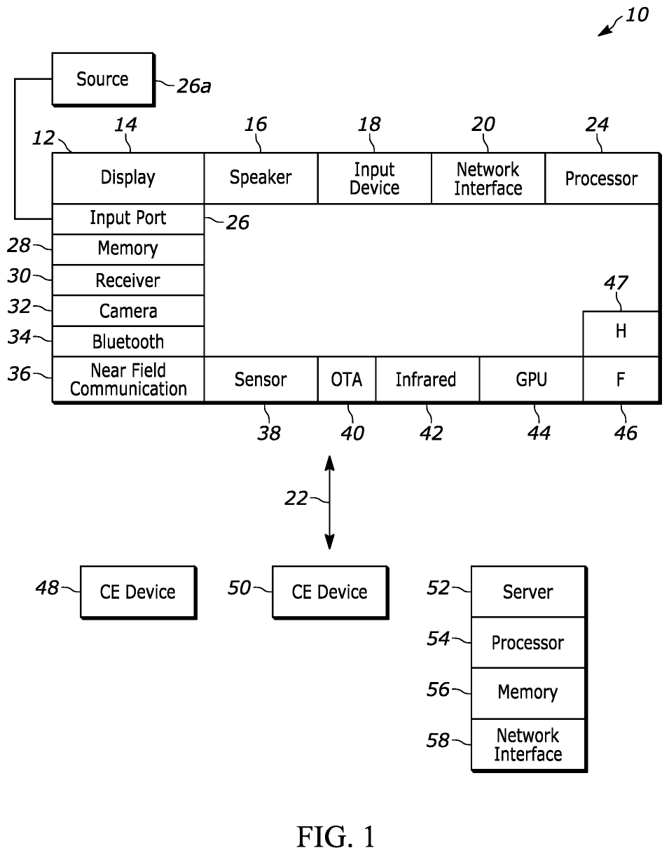

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. Other example input devices include gamepads or mice or keyboards.

The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the aforementioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

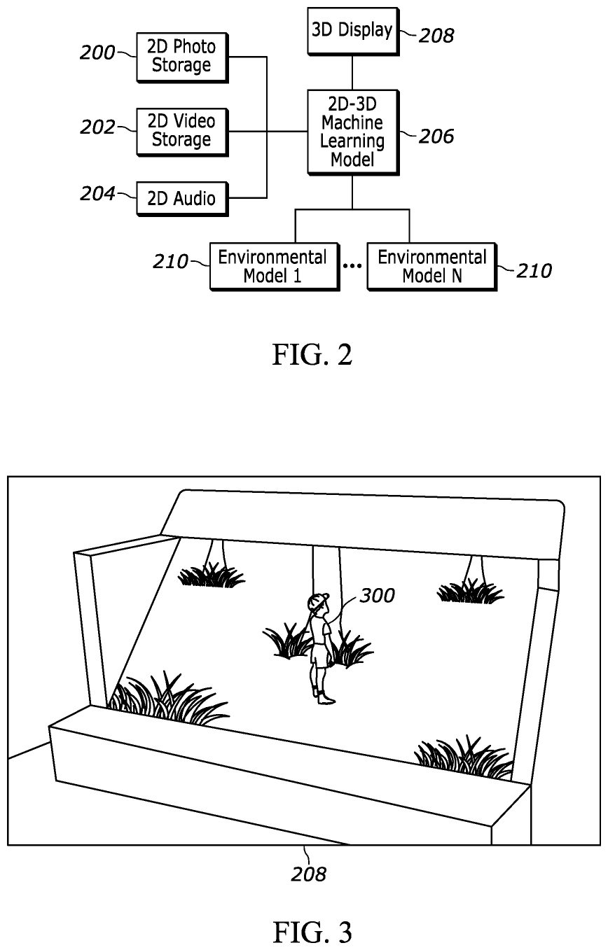

Refer now to FIG. 2 for an example illustration of family/friends interactive 3D video generation for display of content in a 3D spatial memory on a holographic display device placed in the house. 3D spatial memory may include memory 200 storing 2D photographs, memory 202 storing 2D video, and memory 204 storing 2D audio. The 3D spatial memory may be, e.g., on a local server or cloud server. The memories may be combined into a single memory if desired. The memories may be referred to as part of 3D spatial memory because they are accessed by one or more 2D-to-3D models 206 to generate 3D video for presentation on one or more 3D displays 208, such as 3D spatial displays, holographic displays, and VR headsets. The model 206 may be a machine learning (ML) model trained on a training set of 2D images to generate 3D images.

In generating the 3D video, the model 206 may access plural sub-models 210 such as environmental models. Each environmental model may represent a respective environment type, such as beach, lake, mountain, city, and so on. As discussed further herein, information in the 2D storages is used to select which environment type model to select to generate a background for 3D objects that is similar to, but not necessarily exactly the same as, the background in the 2D images, to increase 3D generation speed.

FIG. 3 illustrates the example 3D display 208 implemented as a holographic display presenting a 3D character 300 generated from images in the 2D photos and videos, along with an environmental background 302 generated based on information from the 2D data.

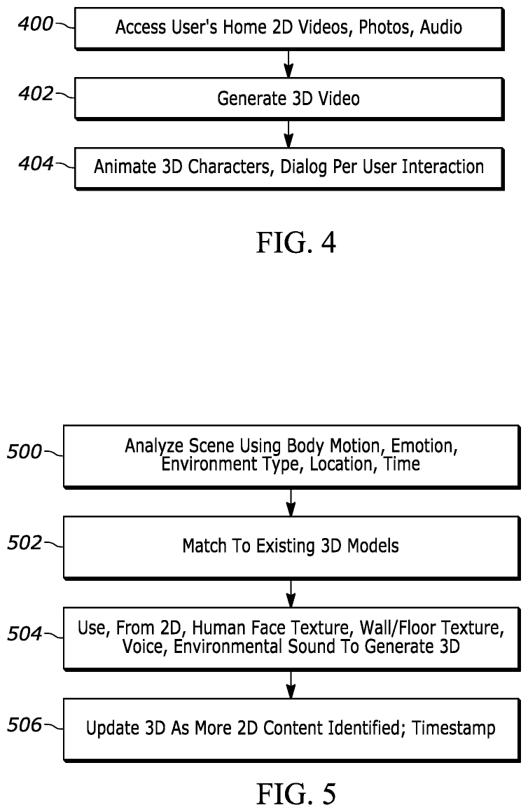

FIG. 4 illustrates example overall logic to enable watching stored reproductions of personal audio-video files, accessed at block 400, that are enhanced by automatically converting (block 402) what is essentially a partial history of the subject into 3D with interactive features (block 404). End users can watch and interact with the copy of their family and friends in the 3D video presented on, e.g., a holographic display device. The system generates 3D interactive contents from existing video and photos. The 3D content is used in 3D viewing devices such as 3D spatial displays, holographic displays, and VR headsets. Created characters and environments can be controlled using an input device such as a gamepad or mouse and keyboard.

FIG. 5 illustrates additional details. At block 500 the logic analyzes the situation/story of a scene from various information that the 2D video/photo contains, such as human body motion, facial emotion, environment type, location and time. Based on this information, objects and features in a prepared 3D content source (e.g., human body, animation, environment map, lighting, sound effects, etc.) are identified at block 502 for generating automatically and transparently to the user final 3D video. As indicated at block 504, part of the textures and data are gathered from the 2D video, including human facial textures, wall and floor textures, audio such as human voices in the 2D video, and environment sounds to update the 3D video at block 506 as additional 2D content is generated by the user. The content can be time-stamped for purposes to be shortly disclosed.

Thus, as indicated at block 506, the 3D memory content keeps updating. The characters (e.g., parents or children) “grow up” in the 3D video with the real users. When a user wants to watch a past memory, the user can control the time in the virtual world being viewed.

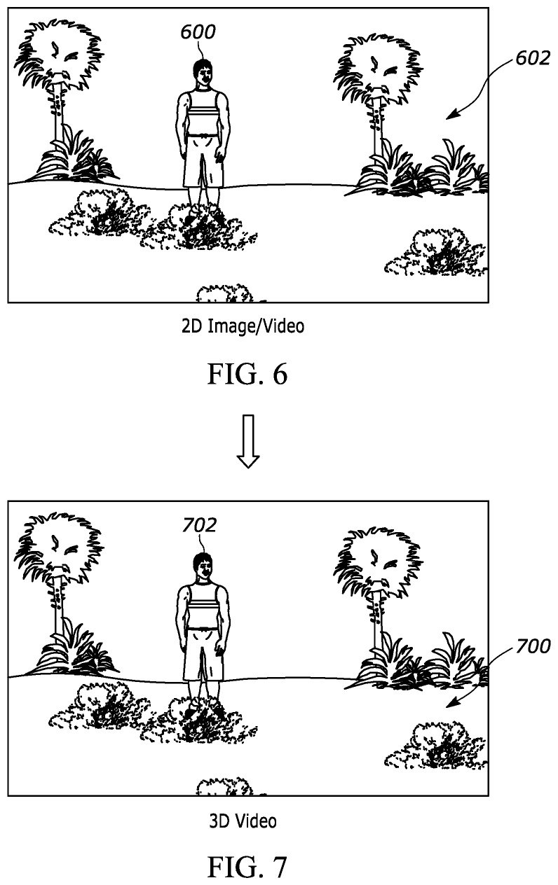

FIGS. 6 and 7 illustrate additional principles. By analyzing, using, for instance, a ML model trained to recognize environment types in images, 2D information including a person 600 and environmental background 602 in FIG. 6, an appropriate 3D model to generate a 3D background image 700 in FIG. 7 of the environmental background 602 in FIG. 6 can be accessed. While both the 2D and 3D environmental backgrounds include trees and grass, the 3D rendering is based, in some embodiments, only on the type of environmental background 602 to render a similar environmental background, but the 3D environmental background 700 need not be an exact 3D rendering of the 2D environmental background 602. This recognizes that so long as the environmental background type remains the same between the 2D and 3D versions of the image, a user viewing the image is not likely to notice or care whether the environmental backgrounds exactly match. If a beach is in the original 2D background, typically any beach environmental background can be used in the 3D rendering, so that processing time can be reduced.

However, for people in 2D images converted to 3D, both person type (to select a “close” model to start with) and 2D texture can be used to render the 3D character 702 in FIG. 7 of the 2D image 600 in FIG. 6. If the image 600 is determined by a ML model for instance to be that of a small girl, a small girl 3D model may be selected and then the texture of the 2D image 600 and if desired facial features of the image 600 applied to render the 3D character 702. This recognizes that as to people, a user viewing the 3D image is likely to notice substantial differences between the 2D image 600 the user may have taken of a friend or family member and the 3D character 702 representing that friend or family member.

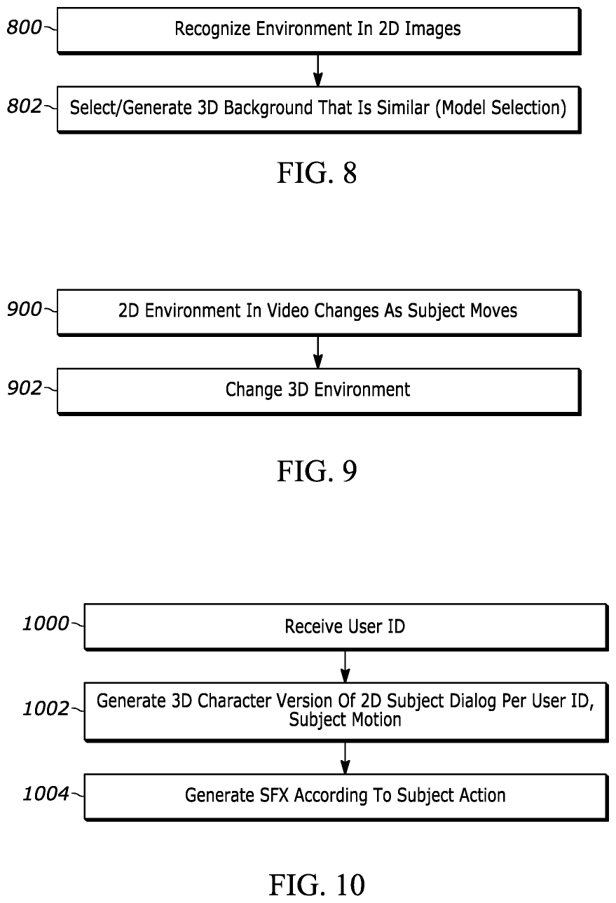

FIGS. 8-10 illustrate further. At block 800 in FIG. 8, an analysis engine such as a ML model recognizes, in the 2D images, a type of background environment. A ML model can be trained to do this using a training set of images of various environmental types with ground truth labels as to what those types are. Proceeding to block 802, a 3D model type is selected based on the output of block 800 to produce a 3D environmental background that is similar to, albeit not perhaps exactly the same as, the actual 2D background image.

FIG. 9 illustrates that as the person imaged at 600 in FIG. 6 in an original 2D video moves, the 2D background may change, and changes are reflected in the 3D video by changing the 3D background environment at block 902 according to the changes in the 2D video.

In some instances the 3D character 702 shown in FIG. 7 may be presented with an audio dialog generated based on the ID of the user viewing the 3D video. The ID of the viewing user is received at block 1000. Based on the type of person the viewer is, e.g., “father”, the 3D character 702 is generated at block 1002 and given a rudimentary dialog to speak on one or more audio speakers. For instance, the 3D character 702 may be animated with mouth motion and using original audio of the person who was originally the subject of the 2D video (image 600 in FIG. 6), made to speak “hello father” or other similar dialog. The viewing listener may choose to speak simple sentences such as “are you OK?” and using voice recognition, a ML model trained on simple dialogs may cause the 3D character to respond “OK” or similar simple response.

Also, as indicated at block 1004, sound effects (SFX″ may be added to the 3D video according to the action of the subject in the video. For instance, if the subject is running on pavement, the sounds of feet on payment may be added to the 3D presentation whenever the feet are hitting the ground.

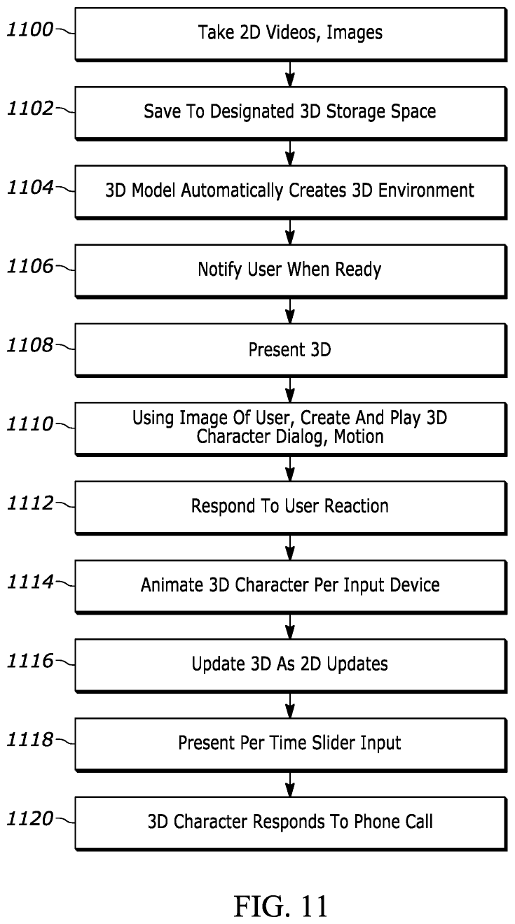

FIG. 11 illustrates details discussed herein. Commencing at block 1100, 2D pictures and videos are taken as usual by any digital camera devices. Moving to block 1102, the pictures/video are saved into the 3D spatial memory service.

Proceeding to block 1104, a ML model accessing the 3D spatial memory automatically creates a 3D environment. As discussed above, the model type selection for the 3D environmental background is minimized according to the 2D information, e.g., the actual environmental background in the 2D image(s) as classified by a ML model.

In addition or alternatively, the environmental background model may be selected based on a geographic region associated with the 2D images as may be indicated in, for instance, metadata associated with the 2D video. Thus, for example, if a video is taken of a person in 2D and the metadata associated with the video indicates “Paris”, the 3D background that is generated may include an image of the Eiffel Tower even if the Eiffel Tower does not appear in the underlying 2D video.

The action in the 3D video is animated to mirror the action in the 2D video. If desired, the type of motion in the 2D video (running, swimming, walking, etc.) can be mapped to a matching motion animation motion model in a database of models to select the model matching the action in 2D. The character in 3D is them animated to move if desired using the appropriate motion model. Language can also be mapped to character motion. For example, if the person in the 2D video says, “watch me run!” word recognition can be applied to extract “run” and select a running motion model based thereon. As stated above, such motion may be used to generate appropriate SFX in the 3D video.

Once the 3D video is ready, the user may be notified at block 1106 using a user interface on an electronic device. The user may then select to watch the 3D video which is correspondingly presented on a 3D display at block 1108.

If desired, an image of the viewing user may be generated at block 1110 using any camera described herein and provided to the 3D generation model to create simple dialog for the 3D character to speak. For example, if the user is recognized as the father and the 3D character is based on an image of his daughter, the 3D model may generate dialog to be played in the voice of the child as recorded in an original 2D video, such as “good morning dad”. The lips of the 3D character may be animated in synchrony with the dialog.

Block 1112 indicates that the 3D character can be made to respond to subsequent user reactions. In this way, viewing users can have simple conversational interactions with virtual characters by voice input. For example, a user might say “good morning”, which is detected by any microphone described herein and recognized using voice recognition processing. This can cause the 3D generation model to play audio in the child's voice that says “hmm . . . Good morning dad. I'm still sleepy”. The 3D character can also respond through body gestures such as facial expressions and hand gestures.

Moving to block 1114, the viewing user can, if desired, control the 3D character using an input device such as a gamepad on a computer simulation controller and interact with other characters in the 3D content world. In this way the viewing user can cause 3D characters to walk around a map, let 3d characters talk, eat food, etc.

Block 1116 indicates that as mentioned above, when updating the analyzing 2D data generated by the user and stored in the 3D memory section, the virtual 3D content is automatically updated to keep showing the latest people memories.

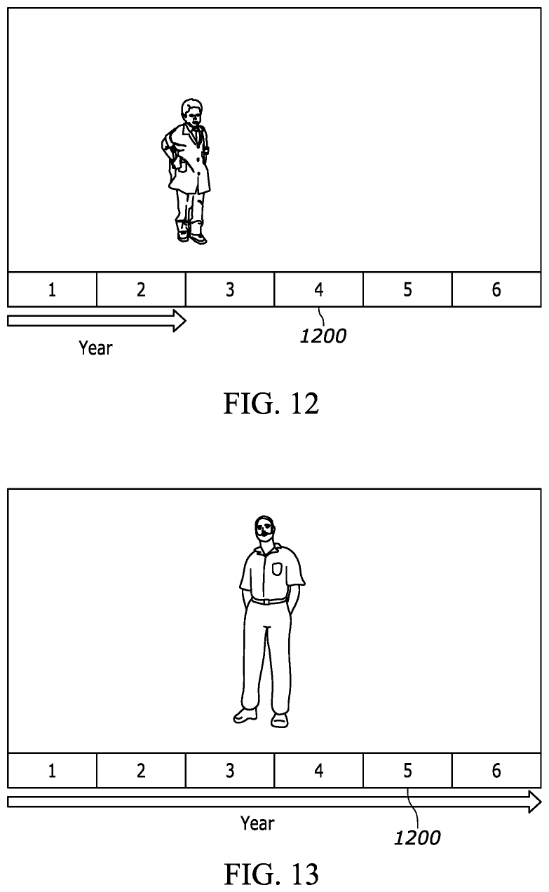

Because of these features, block 1118 indicates that a viewing user can select to watch 3D video depicting a particular time period in the life of the subject of the 3D video. FIGS. 2 and 13 illustrate. A slider 1200 can be moved by the viewing user to select which of six years the user wishes to view the 3D video for. In FIG. 12, the second period (such as a year) of a six-period time span covered by the 3D video is selected, so the 3D video depicts images based on 2D photos and videos taken during the second period. In FIG. 13, the slider 1200 has been moved to the sixth period, so the 3D video depicts images based on 2D photos and videos taken during the sixth period. The use thus can control the time slider 1200 and display any past moments in the virtual 3D world.

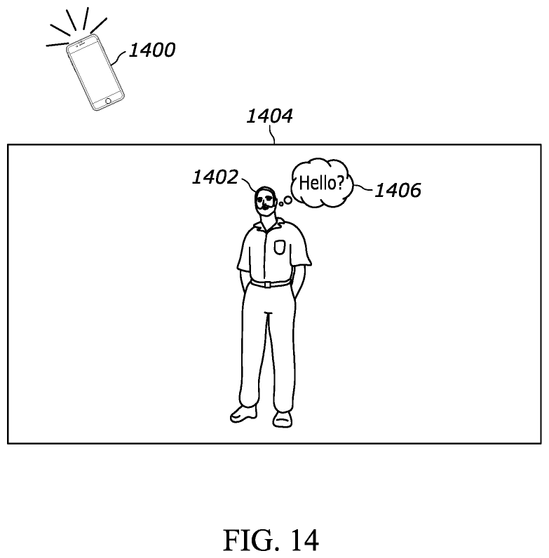

Block 1120 in FIG. 11 and FIG. 14 illustrate that an incoming phone call on a communication device 1400 can be detected and input to the 3D model generation system to cause a 3D character 1402 presented on a 3D display 1404 to audibly respond as indicated by the word 1406 in FIG. 14. When getting a phone call through the system, registered persons 3D model can be animated to talk in synchronization with the voice audio.

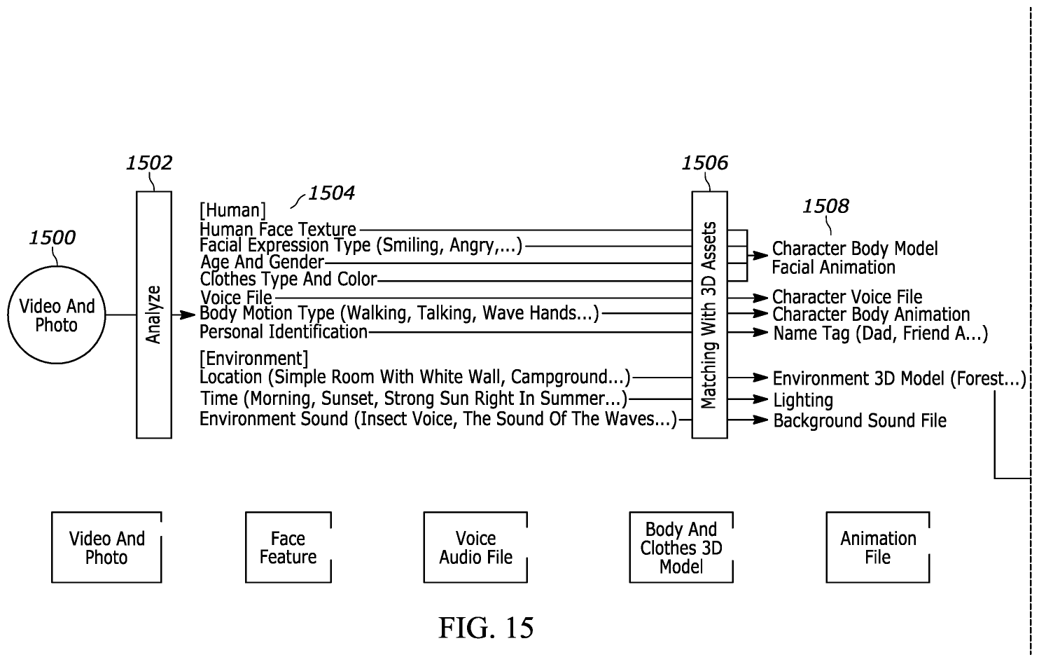

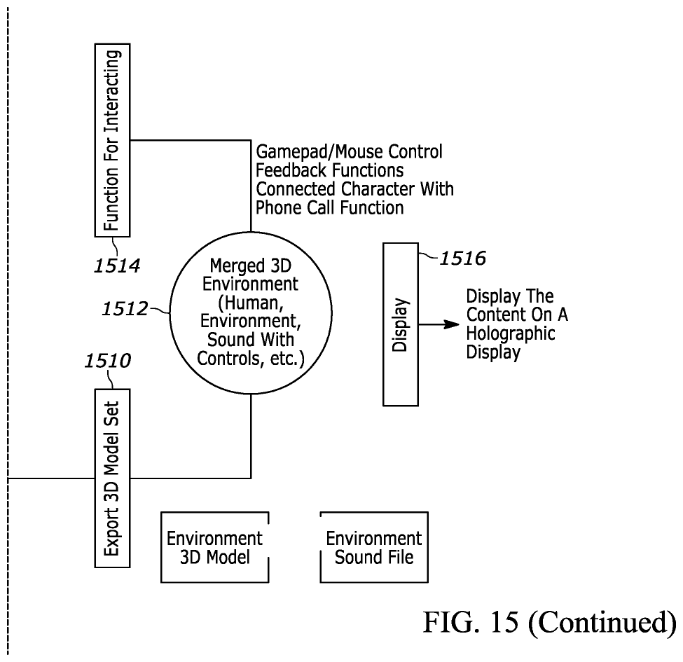

FIG. 15 provides further illustration of principles described herein. 2D video and photos 1500 in the 3D memory space are provided for analysis 1502 to extract features 1504 including human features of people in the 2D images such as face texture, facial expression type, age, gender, clothing type and color, voice files, body motion type (in videos), personal identification. The features also may include environmental features such as location type, time of day and date, and background environmental sounds in 2D videos.

The features 1504 extracted from the 2D data 1500 are provided to a matching model 1506 to select various 3D models 1508 to use in creating the related 3D video. These models may include a character body model, a facial animation model, a character voice file, a character body animation model, a name tag, as well as a background environment model and background sound file.

The 3D models 1508 are exported to a 3D model set 1510 that together merge (1512) the 3D human, environmental, and sound output by the selected 3D models 1508 with functions for interacting 1514 such as input device control of 3D characters, feedback functions, and phone call functions as described above. The merged 3D information is presented on a 3D display 1516 such as a holographic display with audio speakers.

While the particular embodiments are herein shown and described in detail, it is to be understood that the subject matter which is encompassed by the present invention is limited only by the claims.

What is claimed is:

1. An apparatus comprising:
at least one processor configured to:
access 2D image information in storage;
using the 2D image information, generate 3D interactive video at least in part by matching at least one feature of at least one object in the 2D image information to at least one 3D model.

2. The apparatus of claim 1, wherein the processor is configured to:
receive from at least one input device at least one interaction signal; and
alter presentation of the 3D interactive video at least in part based on the interaction signal.

3. The apparatus of claim 2, wherein the input device comprises at least one touch element on at least one computer simulation controller.

4. The apparatus of claim 2, wherein the input device comprises at least one microphone.

5. The apparatus of claim 1, wherein the processor is programmed to:
alter presentation of the 3D interactive video responsive to an incoming telephone call.

6. The apparatus of claim 1, wherein the at least one feature of the 2D image information comprises human image texture.

7. The apparatus of claim 1, wherein the at least one feature of the 2D image information comprises human image motion.

8. The apparatus of claim 1, wherein the at least one feature of the 2D image information comprises human image facial emotion.

9. The apparatus of claim 1, wherein the at least one feature of the 2D image information comprises environment type.

10. The apparatus of claim 1, wherein the processor is programmed to:
alter presentation of the 3D interactive video responsive to input from a time slider input element.

11. A device comprising:
at least one computer storage that is not a transitory signal and that comprises instructions executable by at least one processor to:
identify at least one texture of at least one human image in a 2D image;
use the texture to generate a 3D character;
identify at least one environmental background type in the 2D image;
based at least in part on the environmental background type in the 2D image, select an environmental background type model;
use the environmental background type model to generate a 3D environmental background; and
merge the 3D environmental background with the 3D character to generate a 3D video.

12. The device of claim 11, wherein the instructions are executable to:
present on at least one 3D display the 3D video.

13. The device of claim 11, wherein the instructions are executable to:
receive from at least one input device at least one interaction signal; and
alter presentation of the 3D video at least in part based on the interaction signal.

14. The device of claim 11, wherein the instructions are executable to:
alter presentation of the 3D interactive video responsive to an incoming telephone call.

15. The device of claim 11, comprising the at least one processor.

16. A method, comprising:
accessing 2D images in a 3D spatial memory;
automatically creating a 3D video based on the 2D images at least in part using an environmental background model selected based on an environmental background in the 2D images as classified by a machine learning (ML) model and a texture of an image of a human face in the 2D images.

17. The method of claim 16, comprising:
animating at least one character in the 3D video based on action in the 2D images.

18. The method of claim 16, comprising:
playing audible dialog in the 3D video based at least in part on an image of a user viewing the 3D video.

19. The method of claim 16, comprising:
animating at least one character in the 3D video based on input from an input device.

20. The method of claim 16, comprising:
automatically updating 3D video as 2D images are added to the 3D spatial memory.
